(19) United States
(12) Patent Application Publication
(10) Pub. No.: US 2012/0201202 A1
(43) Pub. Date: Aug. 9, 2012

(54) METHOD FOR UPLINK MULTI-RECEPTION, AND BASE STATION DEVICE USING SAME

(75) Inventors: Sungkwon Hong, Seoul (KR); Kibum Kwon, Ansan-si (KR)

(73) Assignee: PANTECH CO., LTD., Seoul (KR)

(21) Appl. No.: 13/500,615

(22) PCT Filed: Oct. 5, 2010
(86) PCT No.: PCT/KR2010/006805

§ 371 Date: Apr. 5, 2012

(30) Foreign Application Priority Data
Oct. 6, 2009 (KR) 10-2009-0094853

(51) Int. Cl. H04W 4/00

(52) U.S. Cl. 370/328

(57) ABSTRACT

The present specification relates to a wireless communication system, and particularly, to a method for uplink multi-reception in a wireless communication system and to a base station device using same. The present specification relates to an uplink multi-reception technique for enabling two or more base stations including a serving main base station and one or more neighbor base stations, in order to receive data from a user equipment. The base station device checks whether or not the signal received from the user equipment is decoded, receives a transmission ready signal (RPT) from the neighbor base station or exchanges ACK/NACK signals, determines one or more neighbor base stations as selected neighbor base stations in accordance with a predetermined regulation, transmits a transmission request signal to the selected neighbor base stations, and receives data.

### CROSS REFERENCE TO RELATED APPLICATIONS

This application is the National Stage Entry of International Application PCT/KR2010/006805, filed on Oct. 5, 2010, and claims priority from and the benefit of Korean Patent Application No. 10-2009-0094853, filed on Oct. 6, 2009, both of which are incorporated herein by reference for all purposes as if fully set forth herein.

### BACKGROUND

1. Field

The present invention relates to a wireless communication system, and more particularly, to a method for uplink multiple reception in a wireless communication system and a base station device using the method.

2. Discussion of the Background

According to the development of a communication system, consumers including companies and individuals have used various wireless user equipments.

Accordingly, communication service providers have continuously made attempts to expand an existing communication service market through creating a new communication service market for wireless user equipment and providing reliable and cost-effective services.

In the 3^{rd} Generation Partnership Project Long Term Evolution-Advanced (3GPP LTE-A), and the like, a Coordinated Multi-Point (CoMP) transmission/reception system which improves transmission/reception performance by using multiple base stations for the increase of a cell capacity and the improvement of performance of user equipment in a cell boundary region has been discussed.

The CoMP method includes an uplink multiple reception method in which multiple base stations receive a signal transmitted through an uplink by a user equipment and transmit reception results of neighboring base stations except for a serving cell, to the serving cell by using a backhaul channel, and the serving cell improves a performance of the uplink by using the received reception results.

The uplink multiple reception method may be applied to multiple user equipments, as well as single user equipment, and combined with a multiuser interference cancellation method, thereby further improving the uplink performance.

In the CoMP transmission/reception system, the user equipment transmits information to the serving cell in the unit of frames through an uplink and the serving cell transmits an ACK/NACK signal through a downlink depending on success or failure of decoding for each frame.

That is, the user equipment transmits a signal through the uplink to one or more other neighboring base stations in addition to the serving cell which currently provides a service. In this case, the neighboring base station transmits received signals or signals decoded from the received signal to the serving cell through a backhaul channel between the base stations, and the serving cell receives a backhaul channel signal from the neighboring base stations and uses the received backhaul channel signal for decoding of uplink data when it fails to decode the signal received from the corresponding user equipment.

That is, in the conventional CoMP transmission/reception system, an uplink multiple reception process, in which one or more neighboring base stations periodically transmit a bit-frame decoded from an uplink signal of a corresponding user equipment to a serving cell, is performed.

FIG. 1 illustrates a system construction of uplink multiple reception method 1 among the uplink multiple reception methods in an uplink according to a conventional art, and FIG. 2 illustrates a timing diagram for the system construction.

As can be seen in FIG. 1 and FIG. 2, in conventional uplink multiple reception method 1, other neighboring base stations, except for a serving cell, transmit data decoded by themselves to the serving cell through a backhaul channel regardless of success or failure of decoding in the serving cell, and the serving cell performs decoding by using the data received from the other neighboring base stations. Conventional uplink multiple reception method 1 has a drawback of wasting resources of the backhaul channel because a neighboring base station successful in decoding always transmits data of other neighboring base stations to the serving cell.

In order to overcome the drawback, uplink multiple reception method 2 as illustrated in FIG. 3 and FIG. 4 has been proposed for prevention of wasting resources of a backhaul channel.

As can be seen in FIG. 3 and FIG. 4, in conventional uplink multiple reception method 2, a serving cell transmits a result of success or failure of decoding to other base stations in a form of a Transmission Request (REQ) signal through a backhaul channel and other base stations determine whether to transmit data obtained by decoding the received signal by themselves according to the REQ signal of the serving cell.

That is, the serving cell generates the REQ signal and transmits the generated REQ signal to neighboring base stations when it fails to decode, and a neighboring base station successful in decoding among the neighboring base stations receiving the REQ signal transmits a decoded bit-frame to the serving cell.

Conventional uplink multiple reception method 2 illustrated in FIG. 3 and FIG. 4 has an advantage of preventing resources from being unnecessarily transmitted through the backhaul channel, but has drawbacks of still wasting resources of the backhaul channel because all neighboring base stations unnecessarily transmit the data to the serving cell when there are many neighboring base stations successful in decoding and an increase of transmission delay compared to conventional uplink multiple reception method 1. That is, since the serving cell should transmit a REQ signal to the neighboring base stations, receive a decoded frame bit from a part (or an entirety) of the neighboring base stations, select or combine the received decoded frame bit, and then transmit an ACK/NACK signal to user equipment, uplink multiple reception method 2 requires more transmission time compared to uplink multiple reception method 1.

Accordingly, in order to reduce the transmission delay, uplink multiple reception method 3 may be configured and illustrated as FIG. 5.

As can be seen in FIG. 5, in uplink multiple reception method 3, other neighboring base stations except for a serving cell, notify a serving cell of decoding successes through a Transmission Ready (RPT) signal when they succeed in decoding, and the serving cell first notifies user equipment of an ACK/NACK according to the RPT signal, and then receives decoding succeeded data from other neighboring base stations. Uplink multiple reception method 3 has an advantage that the serving cell can rapidly notify the user equipment of the ACK/NACK only with the reception of the RPT signal having a short message.

However, even if uplink multiple reception method 3 is used, in a case where there is a plurality of neighboring base stations successful in decoding and transmitting the RPT signal to the serving cell, the serving cell transmits the REQ signal to all neighboring base stations and receives the data, so uplink multiple reception method 3 still has a drawback of unnecessarily wasting of resources of the backhaul channel likewise to uplink multiple reception method 2.

Further, in the conventional multiple reception methods, a case in which both the serving cell and all neighboring base stations fail to decode causes a problem in data reconstruction, so that the neighboring base stations are necessary to transmit auxiliary data helpful for the decoding of the data according to a decoding failure to the serving cell, but a method of transmitting the auxiliary data has not been prepared.

That is, there is a problem in that there is no determined algorithm enabling the serving cell to receive data from the neighboring base stations when the serving cell fails to decode an uplink signal from the user equipment, when there is a plurality of neighboring base stations successful in decoding of the same uplink signal, when there is no neighboring base station successful in decoding, and the like, or a determined data transmission format.

### SUMMARY

Accordingly, the present invention has been made to solve the above-mentioned problems occurring in the prior art, and the present invention discloses technology for minimizing resources of a backhaul channel by complying with a predetermined rule in an uplink multiple reception, in which a plurality of base stations receives a signal transmitted by user equipment through an uplink and transmits reception results of neighboring base stations except for a serving cell to the serving cell through a backhaul channel, and the serving cell improves an uplink performance by using the received reception results in a wireless communication system.

In accordance with an aspect of the present invention, there is provided an uplink multiple reception method of receiving data from user equipment by two or more base stations including a serving cell currently providing a service and one or more neighboring base stations, the method including: a first step of checking if a signal received from the user equipment is decoded by the serving cell and the one or more neighboring base stations; a second step of, by the serving cell and each of the one or more neighboring base stations, notifying all or a part of other base stations, except for the serving cell and each of the one or more neighboring base stations itself, of a response signal (ACK/NACK signal) indicating a success or a failure of decoding; and a third step of, by each of the neighboring base stations, determining a form of transmission data to be transmitted to the serving cell and whether to transmit the transmission data based on the response signal received from the serving cell and other neighboring base stations, except for each of the neighboring base stations.

In accordance with another aspect of the present invention, there is provided an uplink multiple reception method of receiving data from user equipment by two or more base stations including a serving cell currently providing a service and one or more neighboring base stations, the method including: a first step of checking if a signal received from the user equipment is decoded by the serving cell and the one or more neighboring base stations; a second step of determining a form of transmission data to be transmitted to the serving cell and whether to transmit the transmission data by each of the neighboring base stations; and a third step of transmitting the transmission data to the serving cell by a selected neighboring base station which has determined to transmit the transmission data.

In accordance with another aspect of the present invention, there is provided a base station device as a neighboring base station used in an uplink multiple reception method of receiving data from user equipment by two or more base stations including a serving cell currently providing a service and one or more neighboring base stations, the base station device checking if a signal received from the user equipment is decoded, notifying all or some of other base station devices, except for the base station device itself, of a response signal (ACK/NACK signal) indicating whether the base station device itself succeeds in decoding, determining a form of transmission data to be transmitted to the serving cell and whether to transmit the transmission data based on the response signal transmitted from the serving cell and said other base station devices, except for the base station device itself, and transmitting corresponding transmission data to the serving cell.

In accordance with another aspect of the present invention, there is provided a base station device as a serving cell in an uplink multiple reception method of receiving data from user equipment by two or more base stations including a serving cell currently providing a service and one or more neighboring base stations, the base station device checking if a signal received from the user equipment is decoded, receiving a Transmission Ready (RPT) signal from other neighboring base stations and then determining one or more neighboring base stations as selected neighboring base stations according to a predetermined rule, transmitting a transmission request signal to the selected neighboring base stations, and receiving data.

### BRIEF DESCRIPTION OF THE DRAWINGS

FIG. 1 and FIG. 2 illustrate uplink multiple reception method 1 according to a conventional art.

FIG. 3 and FIG. 4 illustrate uplink multiple reception method 2 according to a conventional art.

FIG. 5 illustrates uplink multiple reception method 3 according to a conventional art.

FIG. 6 is a view illustrating a wireless communication system according to an embodiment of the present invention.

FIG. 7 illustrates operations of base stations according to success or failure of decoding according to an embodiment of the present invention.

FIG. 8, FIG. 9, and FIG. 10 are flowcharts illustrating an uplink multiple reception method according to an embodiment of the present invention.

FIG. 11, FIG. 12, and FIG. 13 are views illustrating an uplink multiple reception method according to another embodiment of the present invention, in which FIG. 11 is a view illustrating data flow in an entire system, FIG. 12 is a flowchart of the uplink multiple reception method, and FIG. 13 is a timing diagram.

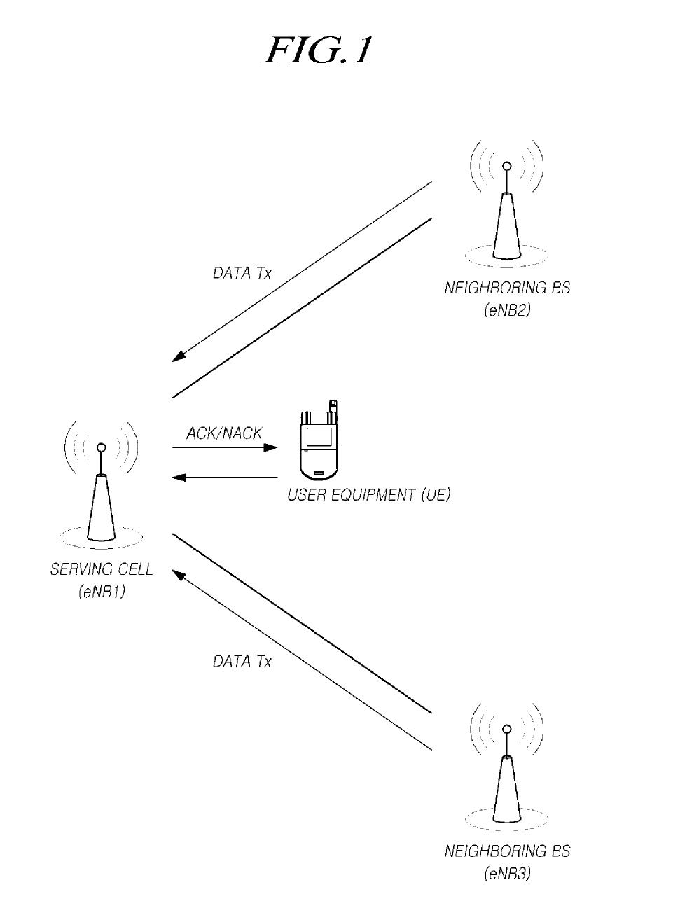

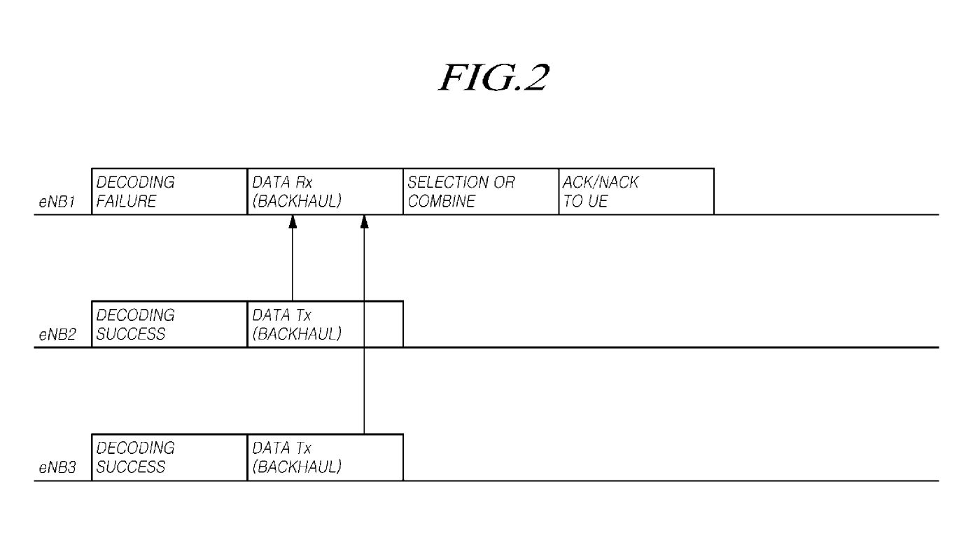

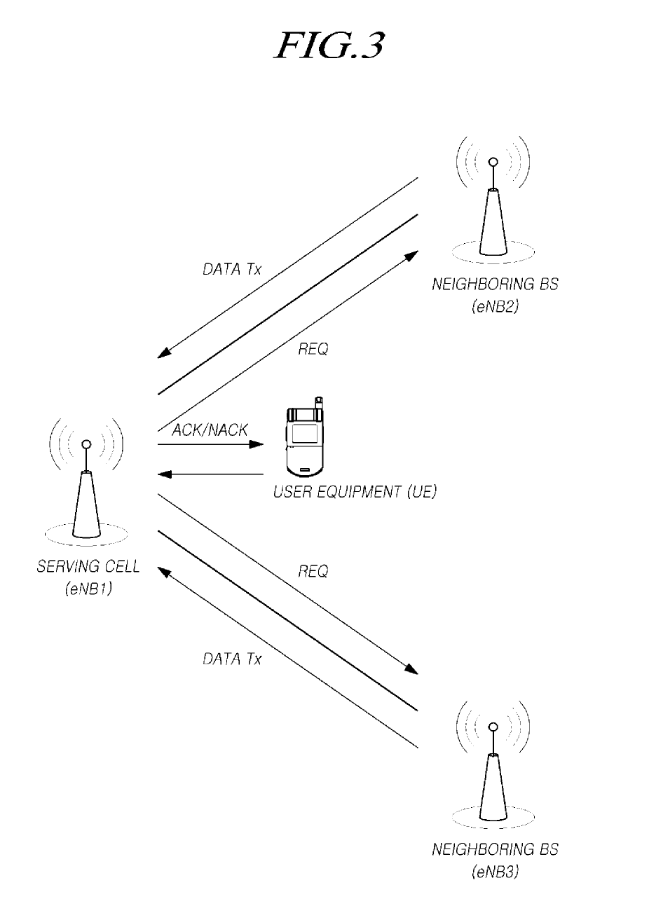

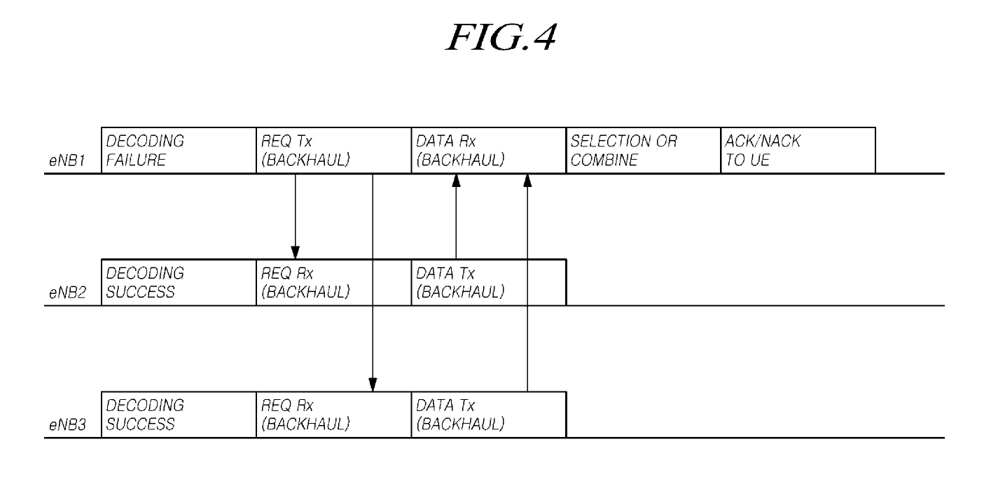

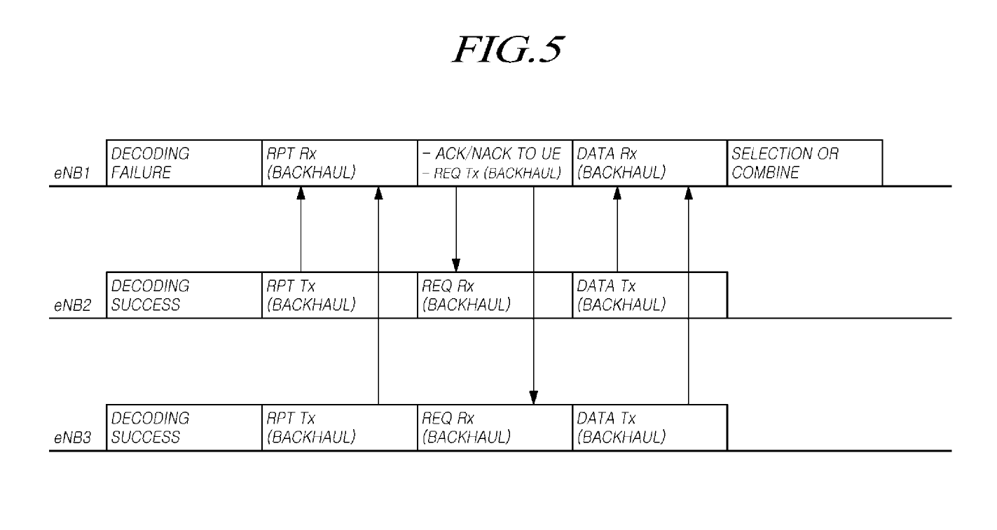

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description, detailed explanation of known related functions and constitutions may be omitted so as to avoid unnecessarily obscuring the subject manner of the present invention.

Further, in describing the constructional elements of the present invention, the terms of a first, a second, A, B, (a), (b), or the like, can be used. Such a term is only for discriminating the constructional element from another constructional element, and does not limit the essential feature, order, or sequence of the constructional element, or the like. If one constructional element is “coupled to”, “assembled with”, or “connected to” another constructional element, one constructional element is directly coupled to or connected to another constructional element, but it can be understood as another different constructional element can be “coupled”, “assembled”, or “connected” between each constructional element.

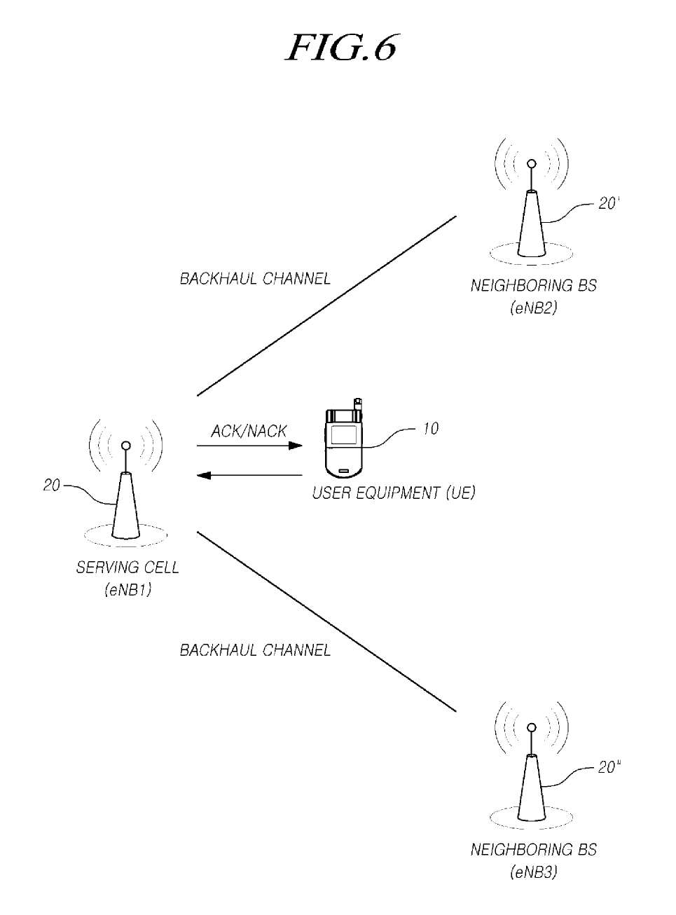

FIG. 6 illustrates an entire construction of a CoMP transmission/reception system according to an embodiment of the present invention.

As illustrated in FIG. 6, in the CoMP transmission/reception system, single User Equipment (UE) 10 is connected to two or more Base Stations (BSs) 20, 20′, and 20″.

That is, the CoMP transmission/reception system includes three BSs eNB1, eNB2, and eNB3 and one UE, and a serving cell eNB1 is connected to other neighboring BSs eNB2 and eNB3 through a backhaul channel. The UE transmits information to the serving cell through an uplink in the unit of frames, and the serving cell transmits an ACK/NACK signal to the UE through a downlink depending on success or failure of decoding for each frame.

That is, one user (UE) may receive services through simultaneous connection to two or more BSs or through connection to a BS having the most desirable channel among a plurality of BSs according to a channel condition in a predetermined time period.

Further, a beam forming value or a pre-coding value exists being set with consideration of only a channel condition with a BS receiving the service in a beam forming or a pre-coding. However, a beam forming value or a pre-coding value may be optimally set by estimating an estimation value or an interference value of a channel condition with neighboring BSs in the CoMP transmission/reception system.

When the BSs and the UE transmit/receive coordinated data in the CoMP transmission/reception system, they are allocated the same frequency resource at the same time and transmit/receive the coordinated data. That is, a plurality of BSs selected as coordinated BSs at the same time transmits/receives data to/from one user equipment by using the same frequency resource. Accordingly, the BSs selected as the coordinated BSs should be BSs having a good channel performance for a predetermined frequency band used for corresponding user equipment.

The user equipment recognizes each BS and a channel condition of an antenna of each by interpreting reference signals transmitted from each of the BSs and directly or indirectly feeds back recognized information to a corresponding BS.

A BS receiving the feedback of the information or a higher layer including a core network selects a BS showing good channel performance and forms a coordinated BS set, and the BSs included in the coordinated BS set initiate coordinated transmission/reception with the corresponding UE.

The two or more BSs included in the coordinated BS set in the CoMP transmission/reception system include the serving cell eNB1 20 which currently provides services, and the neighboring BSs eNB2 20′ and eNB3 20″, other than the serving cell. The number of neighboring BSs, other than the serving cell, is variable.

The UE 10 and the plurality of BSs 20, 20′, and 20″ in the CoMP transmission/reception system transmit/receive data by using an uplink multiple reception method to be described below.

The UE 10 used herein has a general concept including user equipment in a wireless communication, and should be interpreted as a concept including all of a Mobile Station (MS) in a Global System for Mobile Communication (GSM), a User Terminal (UT), a Subscriber Station (SS), and a wireless device, as well as UE in Wide Code Division Multiple Access (WCDMA), Long-Term Evolution (LTE), and High Speed Packet Access (HSPA).

The BS or a cell generally refers to a fixed station communicating with the UE 10, and may be called different terms, such as a Node-B, an evolved Node-B (eNB), a Base Transceiver System (BTS), and an Access Point (AP).

That is, the BS 20 or the cell used herein should be interpreted to have a general meaning indicating a partial area covered by a BS Controller (BSC) in the CPMA, a Node-B in the WCDMA, etc., and have a meaning generally including various coverage areas, such as a mega cell, a macro cell, a micro cell, a pico cell, and a femto cell.

The UE 10 and the BS 20 used herein mean two general types of transmission/reception subjects used for implementation of a technique or a technical spirit described in the present specification, and are not limited by a specifically designated term or word.

There is no limit of the multiple access methods applicable to the wireless communication system. That is, the wireless communication system may employ various multiple access methods, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, and OFDM-CDMA.

Uplink transmission and downlink transmission may employ a Time Division Duplex (TDD) method of transmitting data in different times or a Frequency Division Duplex (FDD) method of transmitting data by using different frequencies.

The embodiment of the present invention may be applied to resource allocation in an asynchronous wireless communication evolved to the LTE and the LTE-advance from the GSM, the WCDMA, and HAPA and a synchronous wireless communication field evolved to the CDMA-2000 and the Ultra Mobile Broadband (UMB). The present invention is not limited to a specific wireless communication field and should be interpreted to include all technical fields to which the spirit of the present invention may be applied.

In an uplink multiple reception method in which two or more BSs including a serving cell currently providing a service and one or more neighboring BSs receive data from the UE according to the embodiment of the present invention, the serving cell and the one or more neighboring BSs check if a signal received from the UE is decoded, each of the neighboring BSs determines a form of transmission data to be transmitted to the serving cell and whether to transmit the transmission data, and a selected neighboring BS, which has determined the transmission of the transmission data, transmits the transmission data to the serving cell.

In this case, when the serving cell fails to decode the signal and when the number of neighboring BSs successful in decoding is two or more, the selected neighboring BS may be determined according to an REQ signal which is selectively transmitted according to a predetermined rule from the serving cell failing to decode the signal. In this event, the predetermined rule used may comply with one or more of an initially predetermined order, such as a cell ID, an order according to previously exchanged information, such as an order of a high Signal to Noise Ratio (SNR) between the BS and the UE, and an order of a large capacity of a backhaul channel or a small transmission delay, but it is not limited thereto.

Further, when two or more neighboring BSs succeed in decoding, each of the neighboring BSs may also directly determine if each of the neighboring BSs corresponds to the selected neighboring BS based on a response signal (ACK/NACK signal) related to success or failure of the decoding received from the serving cell and other neighboring BSs, not based on the REQ signal from the serving cell.

Further, when the serving cell fails to decode and all neighboring BS fail to decode, an entirety or a part of the neighboring BSs are determined as the selected neighboring BSs, and the transmission data may have a form of a soft bit value or an IQ sample value.

In an uplink multiple reception method in which two or more BSs including a serving cell currently providing a service and one or more neighboring BSs receive data from the UE according to another embodiment of the present invention, the serving cell and the one or more neighboring BSs check if a signal received from the UE is decoded, the serving cell and each of the one or more neighboring BSs notify all or a part of other BSs, except for themselves, of a response signal (ACK/NACK signal) indicating whether they succeed in decoding or not, and each of the neighboring BSs determines a form of transmission data to be transmitted to the serving cell and whether to transmit the transmission data based on the response signal received from the serving cell and other neighboring BSs, except for itself, and transmits the corresponding transmission data to the serving cell according to the determination.

In this event, when the serving cell fails to decode the signal, a neighboring BS successful in decoding among the neighboring BSs may transmit a decoding succeeded bit frame as the transmission data to the serving cell according to a predetermined rule, and a neighboring BS failing to decode the signal among the neighboring BSs may transmit a soft bit value or an IQ sample value as the transmission data to the serving cell according to the predetermined rule.

In this case, the predetermined rule used may comply with one or more of an initially predetermined order, such as a cell ID, an order according to previously exchanged information, such as an order of a high Signal to Noise Ratio (SNR) between the BS and the UE, and an order of a large capacity of a backhaul channel or a small transmission delay, but it is not limited thereto.

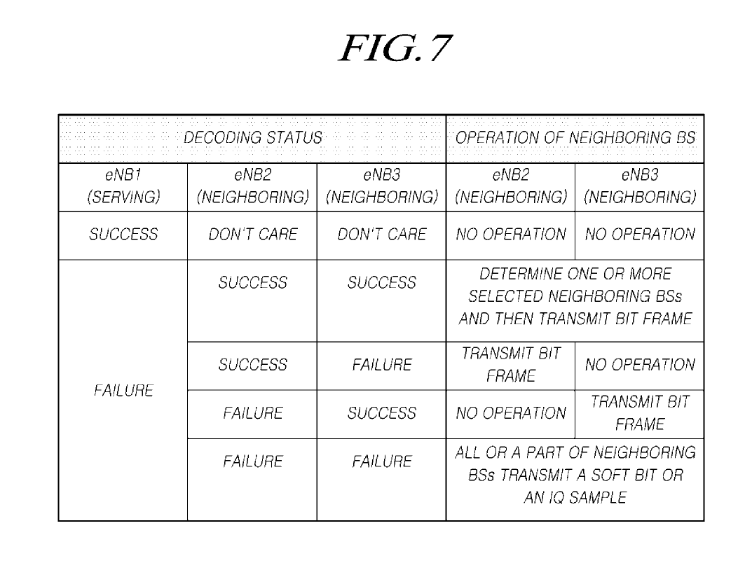

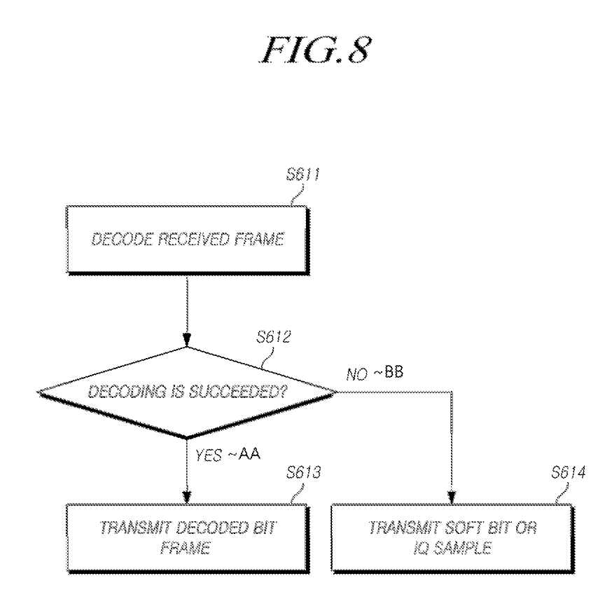

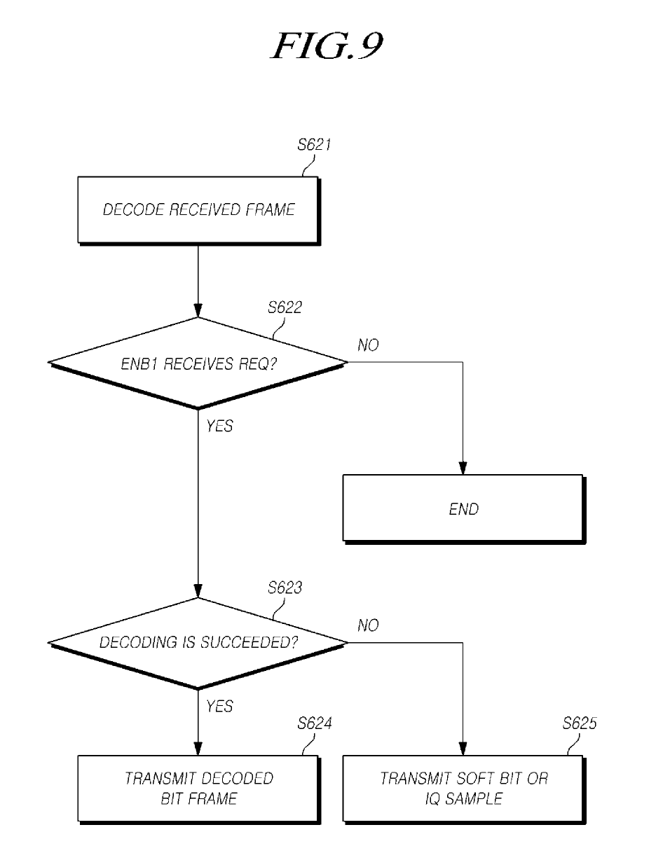

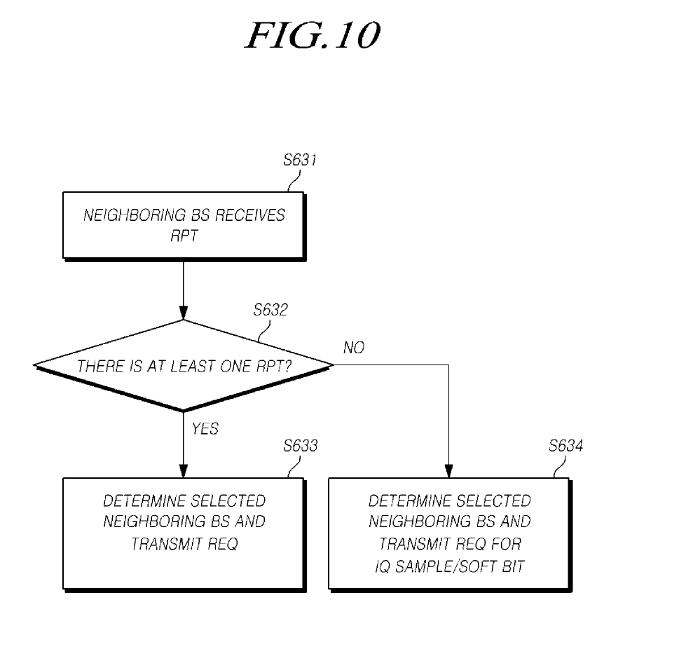

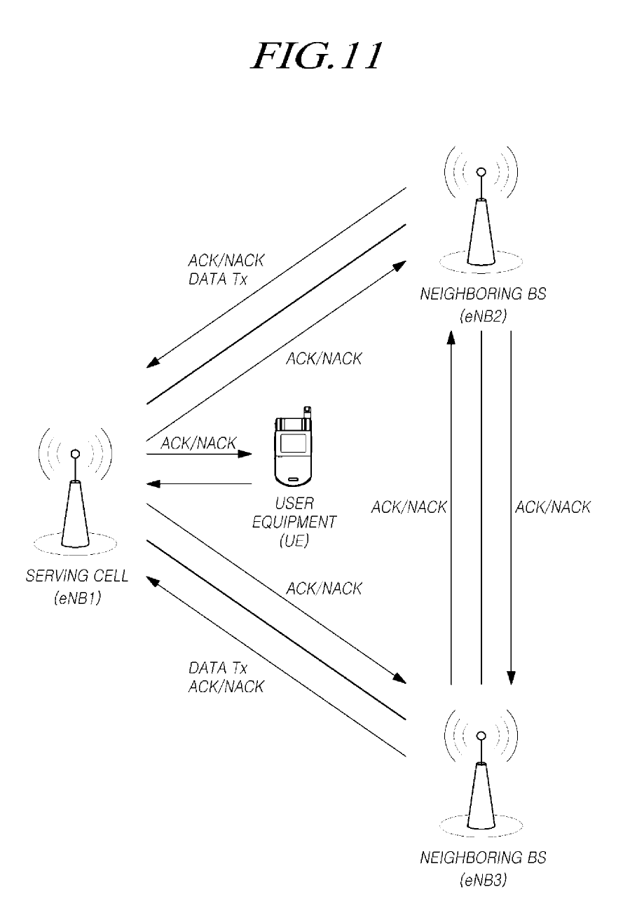

FIG. 7 illustrates operations of the BSs according to whether to decode a signal according to the embodiment of the present invention.

As illustrated in FIG. 7, when the serving cell eNB 1 succeeds in decoding, it has nothing to do with whether the remaining neighboring BSs eNB2 and eNB3 succeed in decoding or not, so that the neighboring BSs do not perform the operation.

In the meantime, when the serving cell fails to decode a signal and only one of the neighboring BS succeeds in decoding of an uplink signal of the same UE, the neighboring BS successful in decoding transmits a decoded bit frame to the serving cell, and the remaining neighboring BSs failing to decode the signal do not need to perform an additional operation.

In the meantime, when the serving cell fails to decode the signal, but when two or more of the neighboring BSs succeed in decoding, one of the neighboring BSs successful in decoding is determined as a selected neighboring BS and only the selected neighboring BS is operated so as to transmit the corresponding bit frame to the serving cell.

In this case, a method of determining the selected neighboring BS generally includes a method in which the serving cell receives RPT signals depending on success or failure of the decoding from the multiple neighboring BSs successful in decoding, selects one neighboring BS according to a predetermined rule, and then transmits an REQ signal to the selected neighboring BS, and a method in which all neighboring BSs transmits/receives a response signal (ACK/NACK signal) indicating whether the decoding is succeeded or failed to/from the serving cell, so that the neighboring BS successful in decoding directly determines if the neighboring BS itself corresponds to the selected neighboring BS.

In this case, the predetermined rule for determining the selected neighboring BS may comply with one or more of an initially predetermined order, such as a cell ID, an order according to previously exchanged information, such as an order of a high Signal to Noise Ratio (SNR) between the BS and the UE, and an order of a large capacity of a backhaul channel or a small transmission delay, but it is not limited thereto.

Last, when the serving cell fails to decode the signal and all of the neighboring BSs fail to decode the signal, the neighboring BSs do not perform any operation according to the conventional art, but according to the embodiment of the present invention, all or a part of the neighboring BSs failing to decode the signal may transmit the soft bit value or the IQ sample value generated according to the decoding failure to the serving cell, and when the part of the neighboring BSs transmit the soft bit value or the IQ sample value to the serving cell, the same predetermined rule as the aforementioned rule may be applied to a process of determining the part of the neighboring BSs as the selected neighboring BSs.

In the meantime, information transmitted from other neighboring BSs other than the serving cell to the serving cell may be data in a form of a decoded bit or a form of an IQ sample signal or a decoded soft bit of a baseband level.

Considering a current technique of configuring a backhaul channel, it fails to provide enough time for the serving cell to combine and decode signals in a form of the soft bit value or the IQ sample transmitted from other BSs due to a node delay or a transmission delay generated in the backhaul channel. That is, a situation where the serving cell cannot use the signal in a form of the soft bit or the IQ sample transmitted from other BSs within a time limit for transmission of the ACK/NACK to the UE is generated. However, in this case, the information provided from other BSs may be combined with a frame retransmitted after the UE receives the NACK signal and used for the decoding, and the technique of configuring the backhaul channel has been continuously developed and a configuration ratio of a backhaul channel having the small transmission and node delay according to an optical transmission channel has been increased.

Accordingly, even when the neighboring BSs fail to decode of the signals, it is preferable that other neighboring BSs transmit the signal in a form of the soft bit or the IQ sample to the serving cell and the serving cell uses the received signal.

That is, in a stance of the serving cell according to one aspect, the successful decoding of a channel symbol received from the UE is the top priority purpose. Further, even if the serving cell fails to decode the channel symbol transferred from the UE, it is okay that the serving cell receives a successfully decoded bitstream from other neighboring BSs. In a stance of the serving cell in another aspect, if any one BS among the neighboring BSs helping to decode in the serving cell succeeds in decoding, whether the remaining BSs succeed in decoding or not is meaningless. When all other neighboring BSs fail to decode the signal, the serving cell may receive the soft bit value or the IQ sample value of other neighboring BSs, combine a channel symbol frame obtained from the UE with a channel estimation value or the soft bit value, and decode the channel symbol frame, thereby improving the transmission performance.

Accordingly, in stances of other neighboring BSs, when other neighboring BSs fail to decode the signal received from the UE, it is preferable that they transmit the soft bit value or the IQ sample value to the serving cell.

The soft bit value means a soft decision value generated in a Maximum A Posteriori (MAP) algorithm and has a performance according to the combination lower than a performance based on the IQ sample value, but the combination based on the soft bit value may be realized only through a simple addition and comparison calculation, so that it has the low calculation complexity, creates a small decoding delay, and demands only a small quantity of resources for transmission of information through the backhaul channel, compared to the IQ sample value.

The IQ sample value means a sample value obtained by down-converting a received RF signal to a baseband signal and means that it is used for the combination together with a channel coefficient value according to the channel estimation. Instead of the channel coefficient value obtained through the channel estimation, a value in a form of a pilot signal or a reference signal prior to the channel estimation may be transferred. Since the combination is generally performed in a baseband and a decoding process is repeated again, the IQ sample value creates a higher complexity and a longer decoding delay, and demands more resources for the transmission of the information through the backhaul channel than the combination based on the soft bit value, but shows a better error rate performance than the combination based on the soft bit value.

Accordingly, a reference for selecting the soft bit value or the IQ sample value is determined in accordance with a requirement and a resource capacity of a system.

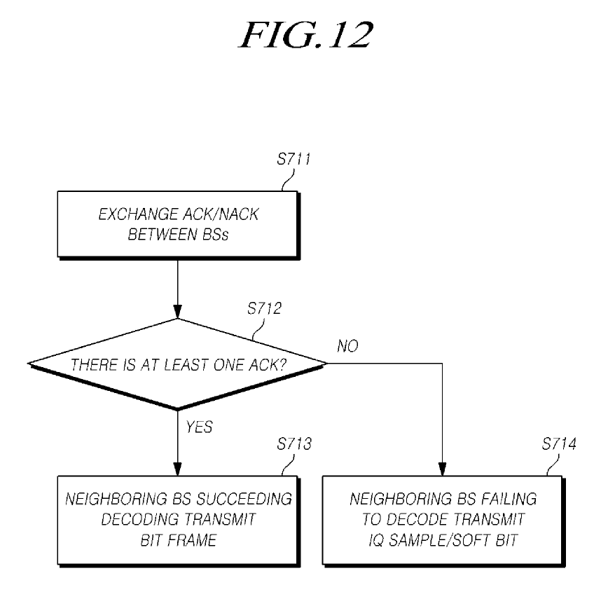

FIG. 8, FIG. 9, and FIG. 10 are flowcharts illustrating an uplink multiple reception method according to an embodiment of the present invention, in which FIG. 8 is an example the uplink multiple reception method according to an embodiment of the present invention applied to conventional multiple reception method 1, FIG. 9 is an example the uplink multiple reception method according to an embodiment of the present invention applied to conventional multiple reception method 2, and FIG. 10 is an example the uplink multiple reception method according to an embodiment of the present invention applied to conventional multiple reception method 3.

As illustrated in FIG. 8, according to the embodiment of the present invention, each of neighboring BSs decodes a received frame received from UE (S611), and determines if it succeeds in decoding the received frame according to completion of an identification of a CRC (S612). Next, each of neighboring BSs transmits a decoded bit frame to a serving cell when each of neighboring BSs succeeds in decoding like the conventional art (S613), but each of neighboring BSs transmits a soft bit value or an IQ sample value to the serving cell when it fails to decode according to the embodiment of the present invention (S614).

As illustrated in FIG. 9, according to another embodiment of the present invention, each of neighboring BSs decodes a received frame received from an UE (S621), and checks if an REQ signal is received from a serving cell eNB1 (S622). When the REQ signal is received, each of neighboring BSs determines if it succeeds in decoding of the received frame according to completion of an identification of a CRC (S623), and each of neighboring BSs transmits a decoded bit frame to the serving cell when it succeeds in decoding, like the conventional art (S624), and each of neighboring BSs transmits a soft bit value or an IQ sample value to the serving cell when it fails to decode according to another embodiment of the present invention (S625).

As illustrated in FIG. 10, according to another embodiment of the present invention, a serving cell failing to decode an uplink signal receives an RPT signal indicating a decoding success from other neighboring BSs (S631), and checks if one or more RPT signals are received (S632). In this case, when the one or more RPT signals are received from the neighboring BSs, the serving cell selects and determines one neighboring BS as a selected neighboring BS according to a predetermined rule, and then transmits an REQ signal for a decoding succeeded bit frame to the selected neighboring BS (S633). When the serving cell fails to receive the RPT signal from any neighboring BS, the serving cell determines one or more neighboring BSs as a selected neighboring BS according to a predetermined rule and then transmits the REQ signal for a soft bit value or an IQ sample value to the corresponding selected neighboring BS (S634). The selected neighboring BS receiving the REQ signal transmits a decoded bit frame or the soft bit/IQ sample value to the serving cell.

In this case, the predetermined rule for determining the selected neighboring BS may comply with one or more of an initially predetermined order, such as a cell ID, an order according to previously exchanged information, such as an order of a high Signal to Noise Ratio (SNR) between the BS and the UE, and an order of a large capacity of a backhaul channel or a small transmission delay, but it is not limited thereto.

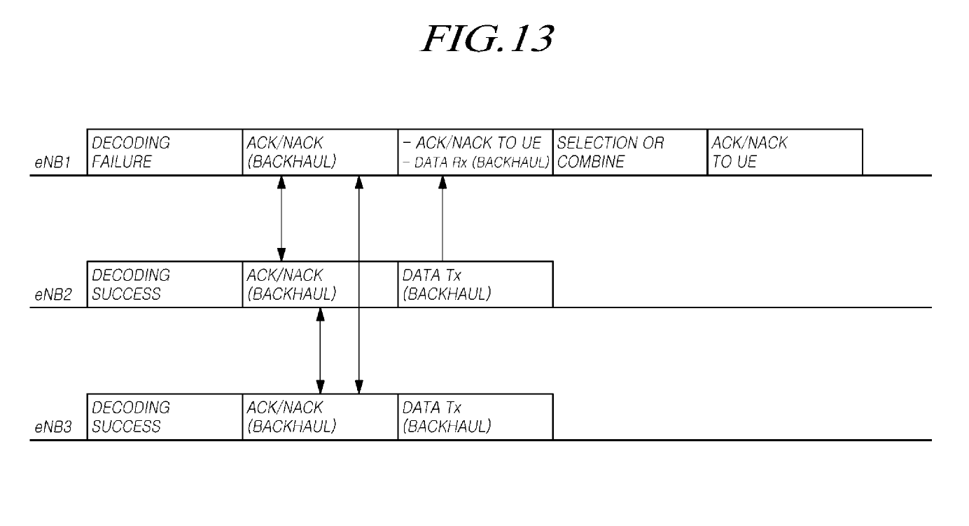

FIG. 11, FIG. 12, and FIG. 13 are views illustrating an uplink multiple reception method according to another embodiment of the present invention, in which FIG. 11 is a view illustrating data flow in an entire system, FIG. 12 is a flowchart of the uplink multiple reception method, and FIG. 13 is a timing diagram.

According to FIG. 11, FIG. 12, and FIG. 13, after decoding of a frame received from UE, a serving cell and each of neighboring BSs transmit a response signal (ACK/NACK) indicating whether they succeed in decoding or not to all BSs except for the serving cell and each of neighboring BSs themselves through a backhaul channel. Accordingly, each BS may recognize whether all BSs including the serving cell and other neighboring BSs succeed in decoding or not.

Then, a type of data and a selected neighboring BS to transmit the data are determined according to success or failure of the decoding, and the corresponding selected neighboring BS(s) transmits information in a determined form.

In this case, contrary to the method illustrated in FIG. 10 in which the serving cell determines the selected neighboring BS, transmits the REQ signal, and receives the data, in the embodiments of FIG. 11, FIG. 12, and FIG. 13, since each of the neighboring BSs is able to recognize whether the serving cell and other neighboring BSs, except for the neighboring BS itself, succeed in decoding, each of the neighboring BSs may directly determine if the neighboring BS itself corresponds to the selected neighboring BS and confirm whether to transmit the data, and also determine the form of the transmission data.

Accordingly, as illustrated in the timing diagram of FIG. 13, the serving cell receives necessary data from the selected neighboring BSs just following a time of exchanging the response signal (ACK/NACK signal) between the BSs, so that the conventional delay according to the transmission of the REQ signal is removed, thereby advantageously preventing the general transmission delay.

Referring to the entire flow, as illustrated in FIG. 12, each of BSs exchanges a response signal (ACK/NACK signal) indicating whether decoding is succeeded after decoding of an uplink signal from user equipment through a backhaul channel (S711). It is checked if there is one or more BSs successful in decoding (S712), and then one of neighboring BSs successful in decoding transmits a decoded bit frame to a serving cell (S713) or all or some of neighboring BSs transmit a soft bit value or an IQ sample value to the serving cell when there is no BS successful in decoding (S714).

In step S713, since each of the neighboring BSs is able to recognize whether the serving cell fails to decode and a neighboring BS successful in decoding among other neighboring BSs, when the serving cell fails to decode, 1) each of the neighboring BSs transmits the bit frame to the serving cell when each of the neighboring BSs itself only succeeds in decoding, 2) each of the neighboring BSs itself directly determines whether to transmit data according to the aforementioned predetermined rule when there are other neighboring BSs successful in decoding, except for each of the neighboring BSs itself, and transmits the bit frame to the serving cell only when each of the neighboring BSs itself is determined to transmit the data, and 3) each of the neighboring BSs determines whether to transmit the data according to the predetermined rule when all neighboring BSs including each of the neighboring BSs itself fail to decode the signal and then transmits the soft bit value or the IQ sample value to the serving cell.

As described above, by using the method of exchanging the response signal (ACK/NACK signal) between the BSs, as illustrated in the timing diagram of FIG. 13, contrary to the transmission of the REQ signal after the identification of all RPT signals by the serving cell in the conventional method, the serving cell simultaneously transmits the response signal (ACK/NACK signal) to the UE and receives the data from other neighboring BSs at the conventional time of the transmission of the REQ signal, thereby preventing the transmission delay.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. An uplink multiple reception method of receiving data from user equipment by two or more base stations including a serving cell currently providing a service and one or more neighboring base stations, the method comprising:
a first step of checking if a signal received from the user equipment is decoded by the serving cell and the one or more neighboring base stations;
a second step of, by the serving cell and each of the one or more neighboring base stations, notifying all or a part of other base stations, except for the serving cell and each of the one or more neighboring base stations itself, of a response signal (Acknowledgement/Negative Acknowledgement (ACK/NACK) signal) indicating a success or a failure of decoding; and
a third step of, by each of the neighboring base stations, determining a form of transmission data to be transmitted to the serving cell and whether to transmit the transmission data based on the response signal received from the serving cell and other neighboring base stations, except for each of the neighboring base stations.

2. The uplink multiple reception method as claimed in claim 1, wherein in the third step, when the serving cell fails to decode the signal, a neighboring base station successful in decoding among the neighboring base stations transmits a decoding succeeded bit frame as the transmission data to the serving cell according to a predetermined rule.

3. The uplink multiple reception method as claimed in claim 1, wherein in the third step, when the serving cell fails to decode the signal, a neighboring base station failing to decode the signal among the neighboring base stations transmits a soft bit value or an IQ sample value as the transmission data to the serving cell according to a predetermined rule.

4. The uplink multiple reception method as claimed in claim 2, wherein the predetermined rule complies with one or more of an initially predetermined order, an order according to previously exchanged information, and an order of a large capacity of a backhaul channel or a small transmission delay.

5. The uplink multiple reception method as claimed in claim 4, wherein the predetermined order is an order of a cell ID of the neighboring base station.

6. The uplink multiple reception method as claimed in claim 4, wherein the order according to the previously exchanged information is an order of the neighboring base station having a large Signal-to-Noise-Ratio (SNR) received from the user equipment.

7. An uplink multiple reception method of receiving data from user equipment by two or more base stations including a serving cell currently providing a service and one or more neighboring base stations, the method comprising:
a first step of checking if a signal received from the user equipment is decoded by the serving cell and the one or more neighboring base stations;
a second step of determining a form of transmission data to be transmitted to the serving cell and whether to transmit the transmission data by each of the neighboring base stations; and
a third step of transmitting the transmission data to the serving cell by a selected neighboring base station which has determined to transmit the transmission data.

8. The uplink multiple reception method as claimed in claim 7, wherein when there are two or more neighboring base stations successful in decoding, the selected neighboring base station is determined according to a transmission request signal which is selectively transmitted by the serving cell failing to decode the signal according to a predetermined rule.

9. The uplink multiple reception method as claimed in claim 8, wherein the predetermined rule complies with one or more of an initially predetermined order, an order according to previously exchanged information, and an order of a large capacity of a backhaul channel or a small transmission delay.

10. The uplink multiple reception method as claimed in claim 7, wherein when there are two or more neighboring base stations successful in the decoding, each of the neighboring base stations determines if each of the neighboring base stations itself corresponds to a selected neighboring base station based on a response signal (ACK/NACK signal) indicating whether the decoding is succeeded or not received from the serving cell and other neighboring base stations.

11. The uplink multiple reception method as claimed in claim 7, wherein when all neighboring base stations fail to decode the signal, all or a part of the neighboring base stations are determined as the selected neighboring base stations, and the form of the transmission data is a soft bit value or an IQ sample value.

12. A base station device as a neighboring base station used in an uplink multiple reception method of receiving data from user equipment by two or more base stations including a serving cell currently providing a service and one or more neighboring base stations, the base station device checking if a signal received from the user equipment is decoded, notifying all or some of other base station devices, except for the base station device itself, of a response signal (Acknowledgement/Negative Acknowledgement (ACK/NACK) signal) indicating whether the base station device itself succeeds in decoding, determining a form of transmission data to be transmitted to the serving cell and whether to transmit the transmission data based on the response signal transmitted from the serving cell and said other base station devices, except for the base station device itself, and transmitting corresponding transmission data to the serving cell.

13. A base station device as a serving cell in an uplink multiple reception method of receiving data from user equipment by two or more base stations including a serving cell currently providing a service and one or more neighboring base stations, the base station device checking if a signal received from the user equipment is decoded, receiving a Transmission Ready (RPT) signal from other neighboring base stations and then determining one or more neighboring base stations as selected neighboring base stations according to a predetermined rule, transmitting a transmission request signal to the selected neighboring base stations, and receiving data.

14. The uplink multiple reception method as claimed in claim 3, wherein the predetermined rule complies with one or more of an initially predetermined order, an order according to previously exchanged information, and an order of a large capacity of a backhaul channel or a small transmission delay.

15. The uplink multiple reception method as claimed in claim 14, wherein the predetermined order is an order of a cell ID of the neighboring base station.

16. The uplink multiple reception method as claimed in claim 14, wherein the order according to the previously exchanged information is an order of the neighboring base station having a large Signal-to-Noise-Ratio (SNR) received from the user equipment.
